(19) United States
(12) Patent Application Publication
(10) Pub. No.: US 2023/0014686 A1
(43) Pub. Date: Jan. 19, 2023

(54) KEY STRUCTURE

(71) Applicant: Primax Electronics Ltd., Taipei (TW)

(72) Inventors: Lei-Lung Tsai, Taipei (TW); Sheng-Fan Chang, Taipei (TW); Che-An Li, Taipei (TW); Chang-Huan Shen, Taipei (TW)

(21) Appl. No.: 17/412,260

(22) Filed: Aug. 26, 2021

(30) Foreign Application Priority Data
Jul. 14, 2021 (TW) 110125955

(51) Int. Cl. H01H 13/7065

(52) U.S. Cl. CPC H01H 13/7065

(57) ABSTRACT

A key structure includes a membrane circuit board, an elastic element and a high impedance layer. The membrane circuit board includes a lower plate, an upper plate, a spacer plate and a circuit layer. The upper plate is located over the lower plate. The upper plate has an opening through the upper plate. The spacer plate is arranged between the lower plate and the upper plate. The circuit layer is arranged between the spacer plate and the upper plate. The elastic element is disposed on the membrane circuit board and substantially aligned with opening. The high impedance layer is disposed on a bottom surface of a bottom part of the elastic element and disposed within the opening of the upper plate. The high impedance layer is in contact with a part of the circuit layer.

### FIELD OF THE INVENTION

The present invention relates to a key structure, and more particularly to a key structure capable of avoiding a ghost key phenomenon.

### BACKGROUND OF THE INVENTION

With increasing development of science and technology, a variety of electronic devices are designed in views of convenience and user-friendliness. For helping the user well operate the electronic devices, the electronic devices are gradually developed in views of humanization. The input devices of the common electronic devices include for example mouse devices, keyboard devices, trackball devices, or the like. Via the keyboard device, texts or symbols can be inputted into the computer system directly. As a consequence, most users and most manufacturers of input devices pay much attention to the development of keyboard devices.

Conventionally, the keys of the keyboard device are arranged in a matrix, which is also referred as a keyboard matrix. When one key is depressed, a keyboard controller scans columns and rows of the keyboard matrix and receives corresponding signals from the columns and the rows. According to the corresponding signals, the keyboard controller recognizes which key is depressed.

However, the states of the keys of the keyboard matrix are usually influenced by each other. If plural keys are pressed down by the user simultaneously, the keyboard controller may be suffered from erroneous judgment. For example, when some keys are pressed down simultaneously, another key that is not depressed may be erroneously judged as a depressed and on-state key. The key that is erroneously judged is referred as a ghost key.

For avoiding the ghost key phenomenon, the keyboard device is further equipped with plural diodes. Each diode is located near the corresponding key intersection. Since the current is allowed to flow through the membrane switch circuit in one direction through the arrangement of the diodes, the ghost key phenomenon can be avoided. However, the arrangement of the diodes near the corresponding key intersections still has some drawbacks. For example, since the diode is not cost-effective, the cost of the keyboard device is increased. In addition, the fabricating process is very complicated.

Therefore, there is a need of providing a keyboard device capable of avoiding the ghost key phenomenon.

### SUMMARY OF THE INVENTION

In accordance with an aspect of the present invention, a key structure is provided. The key structure includes a membrane circuit board, an elastic element and a high impedance layer. The membrane circuit board includes a lower plate, an upper plate, a spacer plate and a circuit layer. The upper plate is located over the lower plate. The upper plate has an opening through the upper plate. The spacer plate is arranged between the lower plate and the upper plate. The circuit layer is arranged between the spacer plate and the upper plate. The elastic element is disposed on the membrane circuit board, and substantially aligned with opening. The high impedance layer is disposed on a bottom surface of a bottom part of the elastic element and disposed within the opening of the upper plate. The high impedance layer is in contact with a part of the circuit layer.

In an embodiment, the high impedance layer is embedded in the circuit layer.

In an embodiment, the circuit layer has a perforation exposing a part of the spacer plate. The high impedance layer is disposed within the perforation of the circuit layer and in contact with the exposed part of the spacer plate.

In an embodiment, the high impedance layer is in contact with a top surface of the part of the circuit layer.

In an embodiment, an impedance value of the high impedance layer is in a range between 2,000 ohms and 6,000 ohms.

In an embodiment, the high impedance layer is made of carbon ink material.

In an embodiment, the elastic element further comprises an edge part connected with the bottom part of the elastic element and disposed on the upper plate of the membrane circuit board. A bottom surface of the edge part is at a level higher than the bottom surface of the bottom part.

In an embodiment, a vertical projection area of the elastic element is larger than a vertical projection area of the opening.

In an embodiment, the high impedance layer is formed on the bottom surface of the bottom part of the elastic element.

In an embodiment, the circuit layer is formed on a top surface of the spacer plate.

From the above descriptions, the key structure of the present invention is equipped with the high impedance layer. The high impedance layer is disposed on the bottom surface of the bottom part of the elastic element and disposed within the opening of the upper plate. In addition, the high impedance layer is in contact with a part of the circuit layer to adjust the equivalent resistance value. Consequently, the ghost key phenomenon can be avoided.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic cross-sectional view illustrating a key structure according to an embodiment of the present invention;

FIG. 2 is a schematic enlarged view illustrating portions of a membrane circuit board and an elastic element of the key structure as shown in FIG. 1; and

FIG. 3 is a schematic enlarged view illustrating portions of a membrane circuit board and an elastic element of a key structure according to another embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

As mentioned in the prior art, the ghost key phenomenon may occur on the existing keyboards. For avoiding the ghost key phenomenon, the keyboard device is further equipped with plural diodes near the corresponding key intersections. However, the arrangement of the diodes is costly, and the fabricating process is very complicated. Therefore, there is a need of providing a keyboard device capable of avoiding the ghost key phenomenon. Particularly, the present invention provides a key structure capable of avoiding the ghost key phenomenon in order to overcome the drawbacks of the conventional technologies. Some examples of the key structure of a keyboard device will be described as follows.

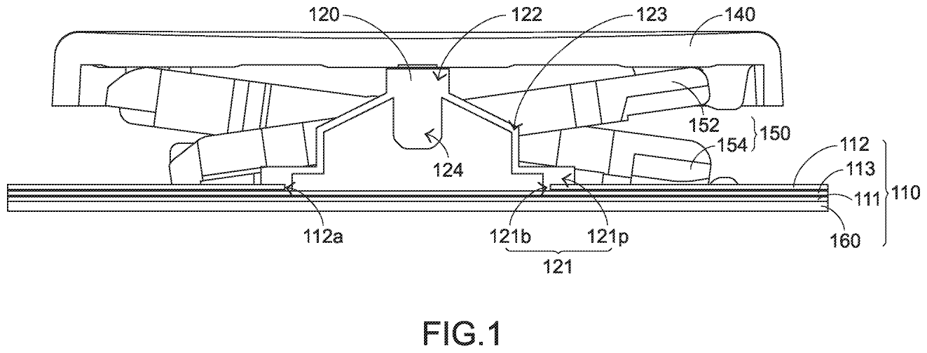

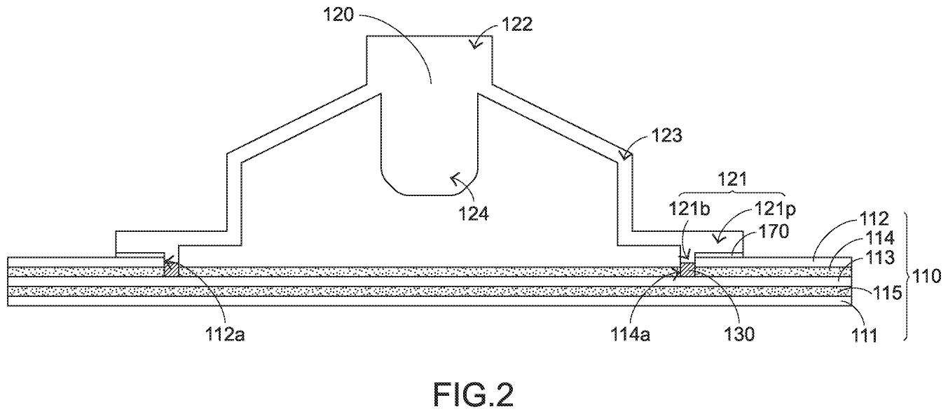

The keyboard device comprises plural key structures. FIG. 1 is a schematic cross-sectional view illustrating a key structure according to an embodiment of the present invention. FIG. 2 is a schematic enlarged view illustrating portions of a membrane circuit board and an elastic element of the key structure as shown in FIG. 1. As shown in FIGS. 1 and 2, the key structure includes a membrane circuit board 110, an elastic element 120 and a high impedance layer 130.

Please refer to FIGS. 1 and 2. The membrane circuit board 110 includes a lower plate 111, an upper plate 112, a spacer plate 113 and a circuit layer 14. The circuit layer 14 is also referred as a first circuit layer 114. The upper plate 112 is located over the lower plate 111. The upper plate 112 has an opening 112a through the upper plate 112. The lower plate 111 and the upper plate 112 may be also referred to as a lower membrane substrate and an upper membrane substrate, respectively. In an embodiment, the lower plate 111 and the upper plate are made of polycarbonate (PC), polyethylene terephthalate (PET), polymethylmethacrylate (PMMA), polyimide (PI) or any other appropriate material.

The spacer plate 113 is arranged between the lower plate 111 and the upper plate 112. In an embodiment, the spacer plate 113 is made of polycarbonate (PC), polyethylene terephthalate (PET), polymethylmethacrylate (PMMA), polyimide (PI) or any other appropriate material.

As shown in FIG. 2, the circuit layer 114 is arranged between the spacer plate 113 and the upper plate 112. In an embodiment, the circuit layer 114 is formed on a top surface of the spacer plate 113. In an embodiment, the circuit layer 114 is formed on the top surface of the spacer plate 113 by using a printing method or any other appropriate method.

Please refer to FIG. 2 again. In an embodiment, the membrane circuit board 110 further includes another circuit layer 115, which is also referred as a second circuit layer. The second circuit layer 115 is arranged between the spacer plate 113 and the lower plate 111. The second circuit layer 115 is formed on a bottom surface of the spacer plate 113. In an embodiment, the second circuit layer 115 is formed on the bottom surface of the spacer plate 113 by using a printing method or any other appropriate method.

The elastic element (also referred as an elastomer) 120 is disposed on the membrane circuit board 110 and substantially aligned with the opening 112a. In this context, the term “two components are substantially aligned with each other” indicates that the projection regions of two components along the vertical direction (i.e., along the thickness directions of the components) are completely overlapped or nearly completely overlapped. In other words, the projection region of the elastic element 120 and the projection region of the opening 112a along the vertical direction are completely or nearly completely overlapped with each other. Preferably but not exclusively, the elastic element 120 is made of non-conductive elastic material such as rubber or silicone. In an embodiment, the vertical projection area of the elastic element 120 is larger than the vertical projection area of the opening 112a.

As shown in FIG. 2, the elastic element 120 includes a bottom part 121b closest to the circuit layer 114. That is, the bottom part 121b is the bottommost portion of the elastic element 120. In an embodiment, the bottom part 121b is in contact with a lateral surface of the opening 112a of the upper plate 112.

In an embodiment, the elastic element 120 further includes an edge part 121p connected with the bottom part 121b and disposed on the upper plate 112. Particularly, the edge part 121p is the outermost portion of the elastic element 120. The edge part 121p is arrange around the bottom part 121b. In an embodiment, the bottom surface of the edge part 121p is at the level higher than the bottom surface of the bottom part 121b. In other words, there is a height difference between the edge part 121p and the bottom part 121b. Preferably but not exclusively, the top surface of the edge 121p and the top surface of the bottom part 121b are coplanar with each other.

Please refer to FIGS. 1 and 2 again. The elastic element 120 includes a lower support portion 121, an upper support portion 122, an elastic portion 123 and a triggering portion 124. The lower support portion 121 is coupled to the membrane circuit board 110. The lower support portion 121 includes the bottom part 121b and the edge part 121p that are mentioned above. The upper support portion 122 is located over the lower support portion 121. The upper support portion 122 is connected with a keycap 140. The elastic portion 123 is connected between the lower support portion 121 and the upper support portion 122. The position of the triggering portion 124 is aligned with the position of a switch element (not shown) of the membrane circuit board 110. When the keycap 140 is depressed, the elastic portion 123 is subjected to deformation. Consequently, the triggering portion 124 is gradually moved downwardly to push the switch element of the membrane circuit board 110.

Please refer to FIG. 2 again. In an embodiment, the key structure further includes an adhesive layer 170 arranged between the edge part 121p of the elastic element 120 and the upper plate 112 of the membrane circuit board 110. Consequently, the lower support portion 121 of the elastic element 120 is fixed on the upper plate 112 of the membrane circuit board 110 through the adhesive layer 170. In an embodiment, the adhesive layer 170 is glue or any other appropriate adhesive material.

As shown in FIG. 2, the high impedance layer 130 is disposed on the bottom surface of the bottom part 121b of the elastic element 120 and disposed within the opening 112a of the upper plate 112. In addition, the high impedance layer 130 is in contact with a part of the circuit layer 114. The arrangement of the high impedance layer 130 can adjust the equivalent resistance value. Consequently, the ghost key phenomenon can be avoided.

The impedance value of the high impedance layer 130 is higher than the impedance value of the circuit layer 114. In an embodiment, the impedance value of the high impedance layer 130 is in the range between 2,000 ohms and 6,000 ohms. In an embodiment, the high impedance layer 130 is made of carbon ink material or any other appropriate high-impedance material. In an embodiment, the impedance value of the circuit layer 114 is in the range between 200 ohms and 450 ohms. In an embodiment, the impedance value of the high impedance layer 130 is 10 to 30 times the impedance value of the circuit layer 114. In practice, the thickness and size of the high impedance layer 130 may be adjusted. Consequently, the impedance value can comply with the practical requirements.

As shown in FIG. 2, the high impedance layer 130 is embedded in the circuit layer 114. In addition, the high impedance layer 130 is in contact with the lateral surface of the part of the circuit layer 114. Consequently, the high impedance layer 130 can provide a good blocking effect for avoiding the ghost key phenomenon. In an embodiment, the high impedance layer 130 is in contact with the lateral surface of the opening 112a of the upper plate 112. In an embodiment, the circuit layer 114 has a perforation 114a exposing a part of the spacer plate 113. The high impedance layer 130 is disposed within the perforation 114a of the circuit layer 114. In addition, the high impedance layer 130 is in contact with the exposed part of the spacer plate 113. In an embodiment, the high impedance layer 130 is in contact with the lateral surface of the perforation 114a of the circuit layer 114. It is noted that numerous modifications and alterations may be made while retaining the teachings of the invention. In some other embodiments, the high impedance layer is embedded in the circuit layer, but the high impedance layer is not in contact with a part of the spacer plate (not shown).

In an embodiment, the high impedance layer 130 is substantially aligned with the bottom part 121b of the elastic element 120. In other words, the projection region of the high impedance layer 130 and the projection region of the opening 112b of the elastic element 120 along the vertical direction are completely or nearly completely overlapped with each other. Preferably but not exclusively, the high impedance layer 130 has a closed shape (e.g., ring-shaped) from a top viewpoint.

In some embodiments, the high impedance layer 130 is formed on the bottom surface of the bottom part 121b of the elastic element 120. In an embodiment, the high impedance layer 130 is formed on the bottom surface of the bottom part 121b of the elastic element 120 by using a spray coating method, a printing method or any appropriate method. Since the high impedance layer 130 is formed on the bottom part 121b of the elastic element 120, it is not necessary to perform two printing procedures. In the two printing procedures, the circuit layer is formed by using the first printing procedure, and the high impedance layer is formed by using the second printing procedure. Since the two printing procedures are not required, it will not face the test of the printing tolerance and processing precision. Consequently, the quality of the finished product is enhanced.

Please refer to FIG. 1 again. In an embodiment, the key structure further includes a keycap 140. In an embodiment, the key structure further includes a scissors-type connecting element 150. The scissors-type connecting element 150 includes an inner frame 152 and an outer frame 154. The outer frame 154 is combined with the inner frame 152. In addition, the outer frame 154 can be swung relative to inner frame 152. In the embodiment of FIG. 1, the key structure further includes a base plate 160 located under the membrane circuit board 110 and the elastic element 120. The scissors-type connecting element 150 is connected between the keycap 140 and the base plate 160.

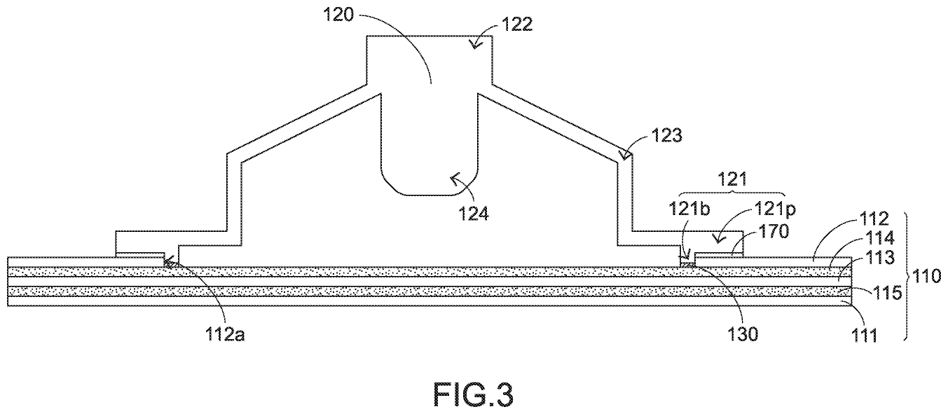

FIG. 3 is a schematic enlarged view illustrating portions of a membrane circuit board and an elastic element according to another embodiment of the present invention. In comparison with the embodiment of FIG. 2, the high impedance layer 130 in the key structure of FIG. 3 is in contact with the top surface of the circuit layer 114 and not embedded in the circuit layer 114.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A key structure, comprising:
a membrane circuit board comprising a lower plate, an upper plate, a spacer plate and a circuit layer, wherein the upper plate is located over the lower plate, and the upper plate has an opening through the upper plate, wherein the spacer plate is arranged between the lower plate and the upper plate, and the circuit layer is arranged between the spacer plate and the upper plate;
an elastic element disposed on the membrane circuit board and substantially aligned with the opening; and
a high impedance layer disposed on a bottom surface of a bottom part of the elastic element and disposed within the opening of the upper plate, wherein the high impedance layer is in contact with a part of the circuit layer.

2. The key structure according to claim 1, wherein the high impedance layer is embedded in the circuit layer.

3. The key structure according to claim 1, wherein the circuit layer has a perforation exposing a part of the spacer plate, wherein the high impedance layer is disposed within the perforation of the circuit layer and in contact with the exposed part of the spacer plate.

4. The key structure according to claim 1, wherein the high impedance layer is in contact with a top surface of the part of the circuit layer.

5. The key structure according to claim 1, wherein an impedance value of the high impedance layer is in a range between 2,000 ohms and 6,000 ohms.

6. The key structure according to claim 1, wherein the high impedance layer is made of carbon ink material.

7. The key structure according to claim 1, wherein the elastic element further comprises an edge part connected with the bottom part of the elastic element and disposed on the upper plate of the membrane circuit board, wherein a bottom surface of the edge part is at a level higher than the bottom surface of the bottom part.

8. The key structure according to claim 1, wherein a vertical projection area of the elastic element is larger than a vertical projection area of the opening.

9. The key structure according to claim 1, wherein the high impedance layer is formed on the bottom surface of the bottom part of the elastic element.

10. The key structure according to claim 1, wherein the circuit layer is formed on a top surface of the spacer plate.
